(19) United States
(12) Patent Application Publication
(10) Pub. No.: US 2004/0059793 A1
(43) Pub. Date: Mar. 25, 2004

(54) Method and system for virtual website domain name service

(76) Inventors: Allen B. Gruber, San Antonio, TX (US); Jeane S. Chen, San Diego, CA (US); Harry E. Gruber, Rancho Santa Fe, CA (US); Ephraim Feig, San Diego, CA (US)

Correspondence Address: Kintera, Inc., Suite 240, 9605 Scranton Road, San Diego, CA, 92121, US

(21) Appl. No.: 10/252,026

(22) Filed: Sep. 20, 2002

(51) Int. Cl. G06F 15/16

(52) U.S. Cl. 709/217

(57) ABSTRACT

A method for creating a virtual uniform resource locator (URL) for a customer wherein the virtual URL is hosted by an application service provider (ASP). The method comprises the steps of registering a wildcard domain name */ASP.net, the wildcard domain name directing requests of the form anyname/ASP.net to ASP's home page ASP.net, creating a virtual URL customer/ASP.net, wherein the customer is named before the ASP, creating a customer subdirectory ASP/customer.net, creating an index containing a list of customer subdirectories and a list of virtual URLs, wherein the index maps a virtual URL to a corresponding customer subdirectory, receiving an http request from a user for a virtual URL, determining the corresponding customer subdirectory for the requested virtual URL from the index, directing the user to the corresponding customer subdirectory.

### BACKGROUND OF THE INVENTION

The Internet uses a set of standards that specify the details of how computers communicate, as well as a set of conventions for interconnecting networks and routing traffic. Two main standards, Transport Control Protocol (TCP) and Internet Protocol (IP), are commonly used together and, when used together, are referred to as TCP/IP.

TCP divides information, such as web pages, into packets of information that are transferred across the network. A packet usually contains only a few hundred bytes of data. For example, a large file to be transmitted between two computers is broken into many packets that are sent across the network one at a time.

IP determines the most efficient routing for each packet of information through the Internet. The most efficient route is determined based on the addresses of the sending and receiving computers. The packets are attached with uniquely identifiable headers and they are reassembled at the destination computer using the headers. The headers contain information such as the addresses of the computers, called IP addresses. Since a message may be divided into numerous packets for transmission and each packet is sent independently, different packets of the same message may take different routes to the destination.

The packets of information travel through different networks, each owned and operated by different entities in different areas. Due to changing network conditions, the shortest path between two points is not always the same. Also, a path that exists one day may not exist the next day. If one section of a network breaks down, a message may still find a path from one point to another. TCP is designed with redundancies and backup measures to handle such issues as the status or reliability of the network. For example, if one packet of a message does not reach the recipient or is corrupted in some way, the sending computer is notified automatically to resend the packet.

The IP address is a series of numbers that identifies each computer linked to the Internet. An IP address consists of four numbers from 0 to 255 separated by dots, such as 198.190.27.105. A computer must have a unique IP address in order to access other computers on the Internet, just as a telephone must have its own unique number before it can call another telephone.

Since it is difficult to remember an IP address consisting of 12 numbers, the DNS, or Domain Name Service, was created for easier addressing of computers on the Internet. The DNS allows common naming of computers on the Internet for convenient addressing. The DNS comprises a collection of registered names, each corresponding to a unique IP address. DNS names are formed as concatenations of names separated by a period. This is done in order to facilitate efficient translation between names and IP addresses. For example, the IP address 198.190.27.105 may be associated with www.computername.com. The naming protocol is governed by accepted standards. The top-level entry in the name identifies the type of organization with which the name is associated, such as, for example, .com (commercial), .net (network provider), .org (nonprofit organization, .edu (educational facility), .mil (military), and .gov (governmental).

Specialized Domain Name Servers spread across the Internet translate domain names to IP addresses and vice-versa. These Domain Name Servers operate in a tree fashion. For example, three Domain Name Servers would be involved in order to locate the IP address of the URL www.computername.com. The three Domain Name Servers may physically reside in one or more computers. First, a root server, which is sending the information, identifies servers that handle “.com.” Typically there would be several servers that handle commercial .com sites. These servers would be queried to find the server for computername.com. Once that server is located, the next step would be to locate the server for www.computername.com. Caching, which holds recently accessed data and is designed to speed up subsequent access to the same data, and mirroring, which duplicates data to more than one device for easy access, typically cuts down the number of queries actually necessary. If the DNS fails to translate a name into an IP address, it responds with an error message such as, for example, “DNS not found.”

A user typically accesses a web page using a browser. The process of accessing the web page www.computername.com is as follows:

1. The user types the domain name www.computername.com in an appropriate place in the browser in a computer (also referred to as a requesting computer);

2. The browser sends a query to a DNS server to translate the domain name to an IP address;

3. The DNS server either responds with an IP address or an error message;

4. The browser then sends an http request for the web page on the server at the identified IP address;

5. The web server responds with an “OK” and sends the requested page;

6. The page, in HTML format, travels back to the requesting computer; and

7. The browser at the requesting computer decodes the page.

A web server has a default web page that is served when an http request is made to the web server's address. Frequently, the default web page is labeled index.html. Thus, when a user requests a web page using the url www.computername.com, the browser automatically interprets this to mean www.computername.com/index.html, where index.html is the default web page of the Web site that resides on the machine whose IP address corresponds to the domain name www.computername.com.

The web site associated with the IP address is itself a hierarchy of web pages, set up as directories and subdirectory with pages in the various directories. Thus, one may make an http request for www.computername.com/directory1/directory2/webpage.html to access an html page called webpage.html that resides in directory2, which in turn is a subdirectory of directory1, which in turn is a subdirectory of the main directory for www.computername.com.

Consider, for example, that a company owns a domain name www.companyname.com. It may also want several other similar but slightly different domain names for other uses. So, it may register different domain names that are similar but slightly different. For example, the domain name w3.companyname.com may be used for an internal site, or the name sales.companyname.com may be used as a site accessible to the company's sales department.

The company may register aliases to www.companyname.com. These are names with the same top-level domain name companyname.com but different left-most names. These aliases are also associated with the same IP address as www.companyname.com. The company may also register a so-called wildcard domain name. In this case, it would register the name *.companyname.com, and then all names of the form “anyname.companyname.com,” where “anyname” represents any name, would be directed to the same home page of the IP address associated with the name *.companyname.com.

Wildcard domain names are not typically used because companies want to reserve different left-most names for different IP addresses. For example, ftp.companyname.com would typically be associated with a different IP address than www.companyname.com, because “ftp” and “www” have different standard accepted meanings. Suppose, companyname.com had a wildcard registration. If a user entered ftp.companyname.com, the user could not be certain if this would be directed to the desired ftp.companyname.com site or the wildcard ftp.companyname.com site; it would all depend on which domain name the Domain Name Server hits first.

When a domain name is registered, the information relating the domain name to its associated IP address is propagated to all Domain Name Servers on the Internet. This process may take several hours, and sometimes can take more than a day.

However, it is often necessary to create web sites and have them immediately accessible, without the several hours or days delay due to new domain name registrations. This is typically done by creating a subdirectory of an existing web site. In essence, these are not new web sites, but sub-sites of existing sites. However, since they can be linked directly from a browser by entering the appropriate URL, they can serve the desired function. A drawback of using this method is that to a viewer these sites indeed look like sub-sites. It is often desirable, from a marketing point of view, to have sites that appear to the viewer as sites in their own right, and not sub-sites of other sites. Companies often advertise URLs in print media, billboards, television, other Web sites or other media. These are intended to be remembered by the viewer who would later, when next to a computer or other device that supports browsing on the Internet, can easily remember the URL, type it in the appropriate place in the browser and then execute the http request to the home page of the associated Web site. It is desirable that the URLs on these print media, billboards, television, other Web sites or other media appear to viewers as sites in their own rights, with very memorable names. It is further desirable to have the name that the owner of the URL wants branded appear prominent in the URL. If that name is already a recognizable brand name and the URL is constructed in a manner such that the brand name is prominently displayed, then it is more likely that a viewer will eventually enter this name in an http request and visit the associated site.

Application Service Providers (ASPs) are services that host web based applications for customers. For example, an ASP may host an e-commerce site for its customers, supplying a catalog of items for sale and the application for executing the sale online. It is desirable for the ASP to be able to automatically generate a web site for a new customer whenever it signs the customer up for service and to have the site up and running immediately. Typically, the ASP will have its own home Web site with a URL, e.g., www.ASPsite.com. It can automate the new e-commerce site for a customer, say Customer1, by creating a sub-site and directing Web traffic to it via the URL www.ASPsite.com/Customer1. This method of direction however has the undesirable affect of drawing a viewer's attention first to the name ASPsite rather than the name Customer1. This may be objectionable to Customer1 who wants the name Customer1 more prominent than the name ASPsite for marketing purposes.

Consider a scenario where an ASP hosts events sponsored by charitable organizations. It is desirable for the ASP to be able to automatically generate a web site for a new event and have the site up and running immediately. If the ASP has its own home Web site with a URL www.ASPsite.com, it can automate the new event site for the organization, say Event1, by creating a sub-site and directing Web traffic to it via the URL www.ASPsite.com/Event1. This method of direction has the undesirable effect of drawing a viewer's attention first to the name ASPsite rather than the name Event1. This may be objectionable to the charitable organization running Event1 that wants the name Event1 more prominent than the name ASPsite for marketing purposes.

Eventually, the ASPsite may become well known and therefore easily recognizable. For example, viewers may recognize ASPsite as a site that hosts events for charitable organizations. This may happen if the name ASPsite appears frequently in print media, billboards, television, other Web sites or other media where it is associated with numerous charitable events. Whereas event names are temporary, as events have finite duration, the name ASPsite will stay the same. Therefore viewers who see a URL of an event hosted by ASPsite will likely remember the name ASPsite but may not remember the exact name associated with a particular event. Nevertheless, the organization running the event may desire that the ASPsite provide a mechanism for assisting the viewer to find the Web site associated with the event.

Accordingly, it is desirable to have a method and system for automating the creation of new sites such that their URLs display prominently the names that the owners of the new sites want recognized. It is desirable to have a URL naming convention that allows organizations to publish their URLs on print media, billboards, television, other Web pages or other media, such that they are prominently displayed. It is also desirable to have a method and system that lists all customers and events that the ASP is hosting and has search capabilities that assist viewers to locate a desired Web site. Also it is desirable to have a new method and a system such that these new URLs need not be registered and assigned new IP addresses so that these new sites can be deployed immediately. It is also desirable to have a method and system that avoid a new registration in order to avoid the costs associated with such new registration.

### BRIEF DESCRIPTION OF THE DRAWINGS

FIG. 1 illustrates a system block diagram of one embodiment of the invention; and

FIG. 2 illustrates a flow diagram of the operational method steps of one embodiment of the invention.

### DETAILED DESCRIPTION OF THE INVENTION

This specification includes two pages of computer program code configured to carry out the steps in accordance with the present invention. The computer program code is incorporated herein by reference it its entirety for all purposes.

The present invention is directed to a system and method that allows an organization such as an Application Service Provider (ASP) to create a virtual uniform resource locator (URL), also referred to as virtual web domain name for a third party such as, for example, a customer. The virtual URL has a URL of the third party's web site that prominently displays the name of the third party in the virtual URL. The third party can be a customer that engages the ASP to host its web site and to provide related services, such as electronic commerce services. The present invention allows the ASP to automatically generate a web site for a new customer and have the web site up and running immediately. Furthermore, the URL of the new web site is not necessarily a long string comprising of one or more nested subdirectories. As will be explained in further details, the URL, which will be called the virtual web domain name, associated with the web site need not be registered and assigned a new IP address. Thus, the web site can be deployed immediately. Moreover, the invention allows the customer to avoid the costs associated with finding and obtaining a new registration of a new domain name by using a virtual domain name.

Consider, for example, a scenario where an ASP hosts an e-commerce site for its customer, Customer1. According to the present invention, the URL for the new e-commerce site of Customer1 will be Customer1.ASPsite.net, which is a virtual domain name. This URL can be used on print media, billboards, television, other Web sites and other ads. This URL prominently displays the name Customer1 before the name ASPsite.net. Thus, it will appear to viewers of the URL on the print media, billboard, television, other Web site or the ad, that Customer1 is serviced by ASPsite.net. By having Customer1 as the first name of a URL, viewers will more likely remember it. The URL Customer1.ASPsite.net has the desired affect of enhancing the prominence of the name Customer1.

In one embodiment of the invention, the ASP registers a wildcard domain name *.ASPsite.net, and associates to it an IP address. Any viewer making any http request of the form Anyname.ASPsite.net will be directed to the same Web page, namely the home page associated with ASPsite.net, such as, for example, www.ASPsite.net/index.html. This home page contains, among other data, a list of all the customer URLs that are serviced by the ASP, and these are hotlinked to their respective Web sites that are hosted by the ASP. These websites comprise Web pages that reside in subdirectories of the main ASPsite Web site www.ASPsite.net. The home page www.ASPsite.net/index.html also provides that, if the name Anyname.ASPsite.net is included in its list of URLs, then the viewer is automatically redirected to the Web site corresponding to Anyname.ASPsite.net. If the name Anyname.ASPsite.net is not included in the list of URLs in the home page, then the viewer sees the page www.ASPsite.net/index.html. The viewer can then manually search for the right customer URL in the list of customer URLs.

According to the invention, when Customer1 registers for a service, a web site for Customer1 is created with a new URL www.ASPsite.net/Customer1. This new URL, however, is not advertised. Rather the web site is promoted with the URL Customer1.ASPsite.net. The URL Customer1.ASPsite.net links to the ASPsite.net home page www.ASPsite.net/index.html, wherein the code in the homepage first extracts the name Customer1.ASPsite.net from the data stream it receives via the http request, next determines that Customer1.ASPsite.net is a name on its list of URLs, and then automatically redirects the viewer to the home page of the newly created site www.ASPsite.net/Customer1.

When a user either enters Customer1.ASPsite.net or clicks on any hyperlink to Customer1.ASPsite.net in a document that supports hyperlinking, such as, for example, a Web page, the viewer is taken automatically to the home page of the site www.ASPdirectory.net/Customer1.

If the URL www.ASPsite.net/Customer1 is not found in the list of URLs in www.ASPsite.net/index.html, then the home page www.ASPsite.net/index.html is returned to the viewer's browser.

When a user is taken to www.ASPsite.net/index.html, which includes a list of all customer URLs, the user can look up any desired customer on this web page. Upon finding the desired URL, the viewer can click on it and be directed to its associated Web site. If the user incorrectly types Customer1's name but still correctly types ASPsite.net, then the user would be directed to www.ASPsite.net/index.html where the user would likely find the correct URL.

Customers may wish to create sites corresponding to various hierarchies of their organization. For example, a customer may want several distinct sites corresponding to several distinct functions or sub-organizations within the customer's organization. For example, the customer may be a retail shop with several departments. For example, Customer1 may have distinct sites for various departments Dept1, . . . , DeptN with addresses www.ASPsite.net/Customer1/DeptJ, where J=1, . . . , N. These URLs are not advertised. Rather the web sites for the departments are promoted with the URLs DeptJatCustomer1.ASPsite.net. These URLs link to the ASPsite.net home page www.ASPsite.net/index.html, wherein the name DeptJatCustomer1.ASPsite.net is extracted from the data stream it receives via an http request, next determines that DeptJatCustomer1.ASPsite.net is a name on its list of URLs, and then automatically redirects the viewer to the home page of the newly created site www.ASPsite.net/Customer1/DeptJ.

Another example of a hierarchical structure of sites has Customer1 a charitable organization with regional offices in various places PlaceJ, each hosting various events Event(J,K). Sites are created for Customer1 at www.ASPsite.net/Customer1/PlaceJ/Event(J,K). Often the events Event(J,K) all have the same name Event(K) for all locations PlaceJ. For example, a charitable organization may have events called WalkAmerica in many locations. Sites for these events may be of the form

www.ASPsite.net/Customer1/SanDiego/WalkAmerica and

www.ASPsite.net/Customer1/Chicago/WalkAmerica. Alternately, the sites may be hierarchically created in the form

www.ASPsite.net/Customer1/WalkAmerica/SanDiego and

www.ASPsite.net/Customer1/WalkAmerica/Chicago.

In another embodiment, the home page contains, among other data, a list of the names of all the customers that are serviced by the ASP, and these are hotlinked to their respective Web sites that are hosted by the ASP. The home page www.ASPsite.net/index.html also provides that if the customer name is contained in its list of names, then the viewer is automatically redirected to the Web site associated with that customer. Otherwise, if the customer name is not contained in the list of customer names in the home page, then the viewer sees the home page www.ASPsite.net/index.html. The viewer can then manually look up the correct customer name in the list of customer names.

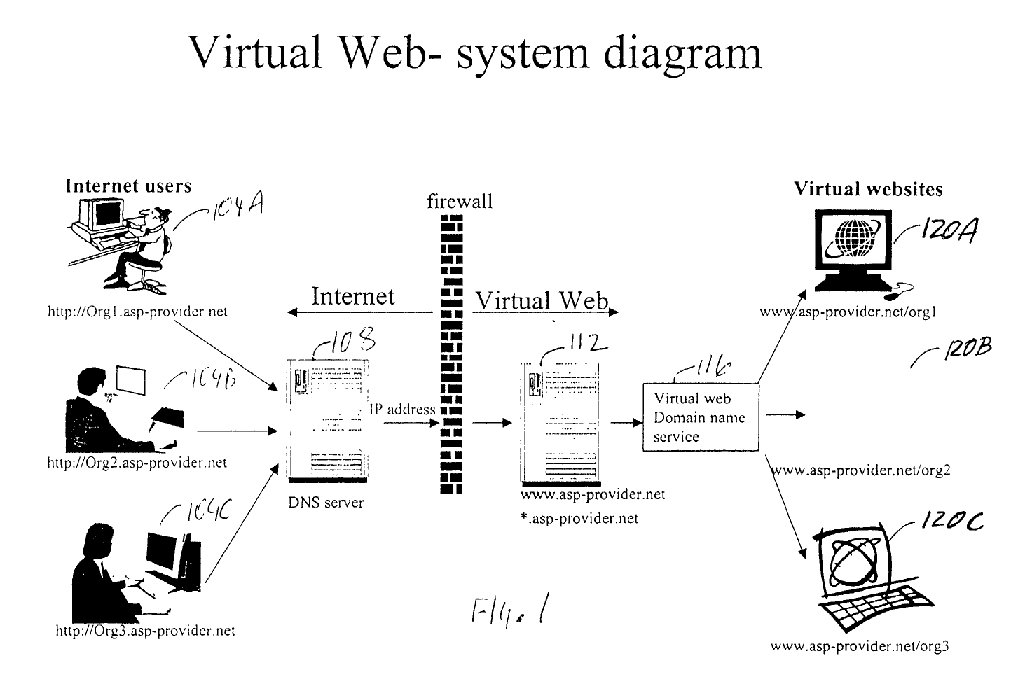

FIG. 1 illustrates a system block diagram of one embodiment of the invention. In FIG. 1, User 104A would like to log onto an organization Org1's web site. User 104B would like to log onto Org2's web site and User 104C would like to log onto Org 3's web site. Org1, Org2 and Org3 are engaged in a fundraising campaign, and have all engaged an ASP (asp-provider.net) to assist in their fundraising campaign.

Consider the case of User 104A. According to the invention, User 104A types the URL http://org1.asp-provider.net on a computer terminal. The URL org1.asp-provider.net prominently displays the name of the organization (org1). The URL is processed by a DNS server 108 that returns an IP address corresponding to a web page 112 for www.asp-provider.net. User 104A is then directed to the web page 112. The web page 112 includes a virtual web domain name server 116 that translates the URL http://org1.asp-provider.net to www.asp-provider.net/org1, where org1 is a subdirectory of the web site asp-provider.net. The subdirectory asp-provider.net/org1 is also referred to as a virtual web site. Thus, User 104A uses the URL org1.asp-provider.net to reach the subdirectory asp-provider.net/org1. Likewise, Users 104B and 104C are directed to the subdirectories asp-provider.net/org2 and asp-provider.net/org3, respectively.

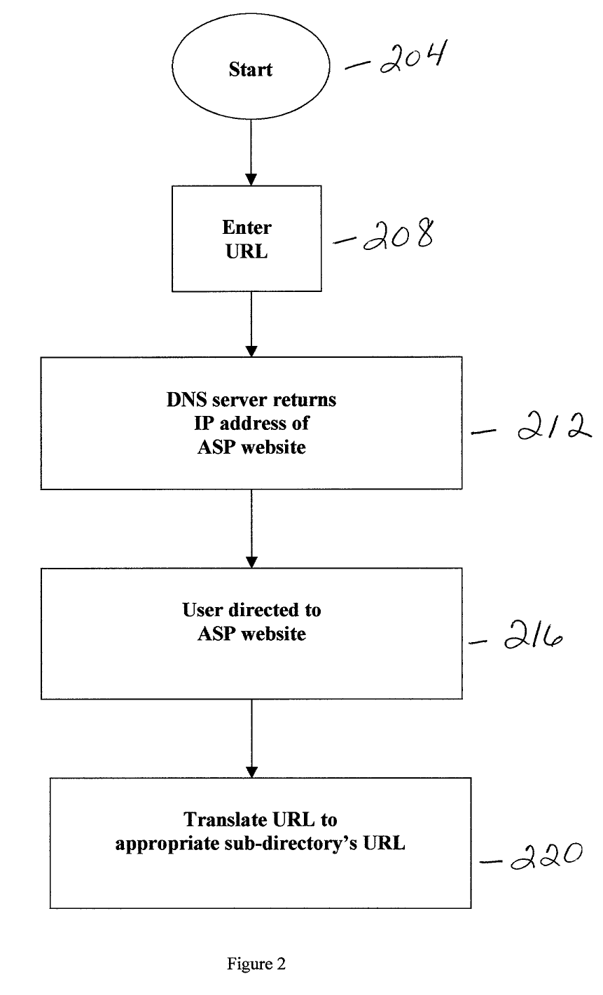

FIG. 2 illustrates a flow diagram of the operational method steps of one embodiment of the invention. The flow starts in step 204 and proceeds to step 208 where a user types in a URL, such as, for example, http://org1.asp-provider.net. In step 212, a DNS server returns an IP address of the ASP's web site. In step 216, the user is directed to the ASP's web site www.asp-provider.net. In step 220, a virtual web domain name service translates the URL http://org1.asp-provider.net to one that directs the viewer to the subdirectory www.asp-provider/org1.

In one embodiment the home page www.ASPsite.net/index.html has a search engine that allows a user to search a customer web site hosted by the ASP. The search engine may prompt the user with specific questions related to the customer. Answers provided to these questions can help narrow the search for the desired web site. The home page may also have spell-checking capabilities that are designed to handle spelling errors. Thus, if the user misspells the name Customer1, the spell-checker may suggest sites with names that closely match those that the user spelled.

If customer sites are constructed in hierarchical fashion as described above, the home page may have the list of sites displayed in hierarchical fashion. This is particularly useful when a user does not know the exact name or URL of an event and has to search for the event on the home page. Thus, in the example of Customer1 with multiple events called WalkAmerica in many locations, the list of event names may be in outline form, with Customer1 as first level entry, then event name as second level entry, and location as third level entry. Such organization helps in the search process.

In one specific embodiment, *.ASPsite.net is a wildcard page for an ASP that services a charitable, a nonprofit, a political or any other organization in its fundraising events. A home page for an event can have a URL EventName.ASPsite.net, where EventName is the name of the event. The name EventName is chosen by the organization with an eye towards maximum recognition and prominence. The fundraising event can include an athletic, a gala, a concert, or any other event hosted to assist in fundraising. The ASP can provide an event template that an organization can customize with the organization's logo and messages. The ASP can provide an online event registration form that can be completed by the organization. After customizing the template and submitting the completed form, an automatic web site for the fundraising event will be generated automatically. The URL for the web site will be EventName.ASPsite.net, where EventName is the name of the event.

What is claimed is:

1. A method for creating a virtual uniform resource locator (URL) for a customer wherein the virtual URL is hosted by an application service provider (ASP), comprising the steps of:
registering a wildcard domain name */ASP.net, the wildcard domain name directing requests of the form anyname/ASP.net to ASP's home page ASP.net;
creating a virtual URL customer/ASP.net, wherein the customer is named before the ASP;
creating a customer subdirectory ASP/customer.net;
creating an index containing a list of customer subdirectories and a list of virtual URLs, wherein the index maps a virtual URL to a corresponding customer subdirectory;
receiving an http request from a user for a virtual URL;
determining the corresponding customer subdirectory for the requested virtual URL from the index;
directing the user to the corresponding customer subdirectory.

2. A method for redirecting a user request for a virtual uniform resource locator (URL) to a customer subdirectory, the virtual URL and the customer subdirectory being hosted by an application service provider (ASP), comprising the steps of:
registering a wildcard domain name */ASP.net, the wildcard domain name directing all requests of the form anyname/ASP.net to ASP's home page ASP.net;
creating a virtual URL customer/ASP.net, wherein the customer is named before the ASP;
creating a customer subdirectory ASP/customer.net;
creating, in the ASP's home page, an index containing a list of customer subdirectories and a list of virtual URLs, wherein the index maps a virtual URL to a corresponding customer subdirectory;
receiving an http request from a user for a virtual URL;
determining the corresponding customer subdirectory for the requested virtual URL from the index; and
directing the user to the corresponding customer subdirectory.
